(19) United States
(12) Patent Application Publication
(10) Pub. No.: US 2013/0235299 A1
(43) Pub. Date: Sep. 12, 2013

(54) REFLECTIVE POLARIZING FILM, MANUFACTURING METHOD THEREOF, POLARIZING PLATE AND BACKLIGHT ASSEMBLY COMPRISING THE REFLECTIVE POLARIZING FILM

(71) Applicant: LG CHEM,LTD., Seoul (KR)

(72) Inventors: Sung-Hyun NAM, Daejeon (KR); Kyun-Il RAH, Daejeon (KR)

(73) Assignee: LG CHEM,LTD., Seoul (KR)

(21) Appl. No.: 13/659,594

(22) Filed: Oct. 24, 2012

(30) Foreign Application Priority Data
Oct. 25, 2011 (KR) 10-2011-0109516

(51) Int. Cl. G02F 1/1335; G02B 5/30; F21V 13/08

(52) U.S. Cl. CPC G02F 1/13362; F21V 13/08; G02B 5/30; G02F 1/133528; Y10S 977/762; Y10S 977/952; B82Y 20/00
USPC 349/61; 362/19; 359/485.01; 349/96; 427/163.1; 977/762; 977/952

(57) ABSTRACT

A reflective polarizing film includes a transparent substrate, and a reflective layer unidirectionally elongated to be formed on one side of the transparent substrate, wherein the reflective layer is composed of nanowire particles, and 80% or more of the nanowire particles are aligned at an angle of −10° to 10° with respect to an elongation direction.

### CROSS-REFERENCE TO RELATED APPLICATIONS

This application claims the priority of Korean Patent Application No. 2011-0109516 filed on Oct. 25, 2011, in the Korean Intellectual Property Office, the disclosure of which is incorporated herein by reference.

### BACKGROUND OF THE INVENTION

1. Field of the Invention

The present invention relates to a reflective polarizing film for improving luminance of a liquid crystal display device and a method for manufacturing the same, and more particularly, to a reflective polarizing film including a nanowire grid and a method for manufacturing the same.

2. Description of the Related Art

Recently, improving the quality of a liquid crystal display device driven in a liquid crystal mode such as an in-plane switching (IPS) mode, a twisted nematic (TN) mode, a vertically aligned (VA) mode, or a fringe field switching (FFS) mode has been attempted by improving optical performance of the liquid crystal display device. In particular, improving luminance of the liquid crystal display device for the purpose of improving the optical performance thereof has been attempted.

To improve luminance of the liquid crystal display device, it has been suggested to provide a polarizing plate having a luminance-improving film attached to one side thereof and to provide a backlight assembly including the luminance-improving film.

As an example of the luminance-improving film, a dual brightness enhanced film (DBEF) is used. However, a DBEF manufacturing process of is relatively complicated, and manufacturing costs thereof are high.

Further, as an example of the luminance-improving film, a nanowire grid polarizer is used. Here, a nanowire grid polarizer, according to the related art, is formed by depositing nanowire particles on one side of a substrate and by then patterning the deposited nanowire particles to have a linear shape or is formed by forming a nanostructure on one side of the substrate and by then depositing nanowire particles on the nanostructure. Therefore, for the patterning, a thin film deposition process, a photoresist coating process, a lithography process, and an etching process are needed. As a result, a manufacturing process of the nanowire grid polarizer according to the related art is relatively completed and a manufacturing cost thereof is high.

Therefore, the need exists for a luminance-improving film which has excellent optical performance but is manufactured through a simple process at a low cost to be developed.

### SUMMARY OF THE INVENTION

An aspect of the present invention provides a reflective polarizing film including a nanowire grid for improving luminance of an image display device and a method for manufacturing the same.

Another aspect of the present invention provides a polarizing plate and a liquid crystal display device including the reflective polarizing film.

According to an aspect of the present invention, there is provided a reflective polarizing film including a transparent substrate, and a reflective layer unidirectionally elongated to be formed on one side of the transparent substrate, wherein the reflective layer is composed of nanowire particles, and 80% or more of the nanowire particles are aligned at an angle of −10° to 10° with respect to an elongation direction.

According to another aspect of the present invention, there is provided a method of manufacturing a reflective polarizing film, the method including the steps of: a) swelling a transparent substrate to have a swelling ratio of 40% or more and less than 60% by using a swelling solution; b) coating a solution including nanowire particles onto one side of the swelled transparent substrate; c) unidirectionally elongating the coated transparent substrate; d) predrying the elongated transparent substrate; and e) drying the predried transparent substrate.

According to another aspect of the present invention, there is provided a polarizing plate and a backlight assembly including the above-described reflective polarizing film, and there is provided a liquid crystal display device including the polarizing plate or the backlight assembly.

### BRIEF DESCRIPTION OF THE DRAWINGS

FIG. 1 is a reflection-type microscope image illustrating an alignment degree of nanowire particles of a reflective polarizing film according to an embodiment of the present invention;

FIG. 2 is a reflection-type microscope image illustrating an alignment degree of nanowire particles of a reflective polarizing film according to comparative example 1;

FIG. 3 is a reflection-type microscope image illustrating an alignment degree of nanowire particles of a reflective polarizing film according to comparative example 2;

FIG. 4 is a reflection-type microscope image illustrating an alignment degree of nanowire particles of a reflective polarizing film according to comparative example 3;

FIG. 5 is a reflection-type microscope image illustrating breakage of a reflective polarizing film during elongation thereof according to comparative example 4;

FIGS. 6A and 6B respectively illustrate a TM polarization direction and TE polarization direction of light penetrating aligned nanowire particles;

FIG. 6C illustrates a relationship between the alignment direction of nanowire particles and the TM and TE polarizations;

FIG. 7 is a graph illustrating transmittance of the reflective polarizing film of the example with respect to polarization;

FIG. 8 is a graph illustrating a comparison between transmittances of the reflective polarizing films of the example and comparative example 1 with respect to polarization;

FIG. 9 is a graph illustrating a comparison between transmittances of the reflective polarizing films of the example and comparative example 2 with respect to polarization;

FIG. 10 is a graph illustrating comparison between transmittances of the reflective polarizing films of the example and comparative example 3 with respect to polarization; and

FIG. 11 is a graph illustrating an extinction ratio of the reflective polarizing film of the example with respect to polarization.

### DETAILED DESCRIPTION OF THE PREFERRED EMBODIMENT

Preferred embodiments of the present invention will now be described more fully. The invention, however, may be embodied in various different forms, and should not be construed as being limited only to the illustrated embodiments. Rather, these embodiments are provided as examples, to convey the concept of the invention to one skilled in the art.

A reflective polarizing film according to the present invention includes a transparent substrate and a reflective layer formed on one side of the transparent substrate.

The transparent substrate may be a water-swellable substrate. Here, the water-swellable substrate refers to a substrate of which a swelling ratio increases in water or a water-based solution. For instance, the water-swellable substrate is manufactured by using a polyvinyl alcohol-based copolymer such as a polyvinyl acetate-vinyl alcohol copolymer, a polyethylene-vinyl alcohol copolymer, a polyvinyl alcohol-styrene copolymer, polyvinyl alcohol-vinyl chloride copolymer, and a polyvinyl alcohol-(meth)acryl copolymer, a cellulose polymer such as triacetyl cellulose, polypropylene glycol, polytetraethylene glycol, polybenzyl alcohol, and a water-soluble polymer including a plurality of hydroxyl groups (—OH) on a polymer chain or composed of a copolymer thereof. The water-swellable substrate may be manufactured by using polyvinyl alcohol and a polyvinyl alcohol-based copolymer.

A thickness of the transparent substrate is not particularly limited. However, the substrate should be mechanically stable in the case in which the substrate is coated with nanowire particles, possibility of breakage of the substrate should be reduced when the substrate swells and expands, and occurrence of curling should be minimized when a polarizing plate of a reflective polarizer is attached. To this end, the thickness of the transparent substrate may be 30 μm to 150 μm, more specifically, 30 μm to 120 μm, and even more specifically, 40 μm to 120 μm.

The reflective layer is unidirectionally elongated to be formed on one side of the transparent substrate. This is for manufacturing a nanowire grid-type reflective polarizing film without performing a series of patterning processes.

The reflective layer is composed of nanowire particles. Here, 80% or more (specifically, 80% to 100% or 80% to 95%) of the nanowire particles may be aligned at an angle of −10° to 10° with respect to the elongation direction. By virtue of the elongation of the transparent substrate, the nanowire particles constituting the reflective layer are aligned in almost the same direction as the elongation direction, and, by adjusting swelling conditions before elongation and elongation conditions, distribution of the aligned nanowire particles is adjusted so that the above-mentioned portion (80% or more) of the nanowire particles are aligned at an angle of −10° to 10°, with respect to the elongation direction. Therefore, an alignment degree of the nanowire particles may be optimized and polarization resolution may be optimized.

The elongation may be performed after the transparent substrate has swollen. This is for improving an elongation ratio to improve an alignment degree of the nanowire particles.

The elongation may be performed when a swelling ratio of the transparent substrate is 40% or more and less than 60%. When the swelling ratio is less than 40%, the substrate does not swell sufficiently and thus, the alignment degree of the nanowire particles decreases, thereby degrading the polarization resolution. When the swelling ratio is 60% or more, a plasticizer of the substrate (e.g. a polyvinyl alcohol-based substrate) leaks, and thus the possibility of breakage of the substrate becomes high during an elongation process.

The elongation ratio may be 50% to 1000% with respect to a length of the swollen transparent substrate. When the elongation ratio is less than 50%, the alignment degree of the nanowire particles decreases and thus, it is difficult to serve as a reflective polarizer. When the elongation ratio is more than 1000%, the substrate may be broken during a manufacturing process.

A method for the elongation is not particularly limited, and thus a conventional method may be performed by using an appropriate elongator such as a tender elongator.

The nanowire particles of the reflective layer are formed of metal or inorganic materials, e.g. gold, silver, copper, aluminum, iron, nickel, titanium, tungsten, and chrome, more specifically, gold, silver, aluminum, and chrome, and furthermore specifically, gold, silver, and aluminum.

A thickness of the reflective layer relates to a wavelength of reflected light. To reflect visible light, the thickness may be 50 nm to 1000 nm, more specifically, 80 nm to 500 nm. When the thickness of the reflective layer is out of the thickness range (50 nm to 1000 nm), the reflective layer reflects light of an unintended wavelength (e.g. UV and IR), and thus it is difficult to use the reflective polarizing film as an optical film for a display.

A reflective polarizing film manufacturing method according to the present invention uses a transparent substrate and includes a) a swelling step, b) a coating step, c) an elongation step, d) a predrying step, and e) a drying step.

The transparent substrate may be a water-swellable substrate. Here, the water-swellable substrate refers to a substrate of which a swelling ratio increases in water or a water-based solution. For instance, the water-swellable substrate is manufactured by using a polyvinyl alcohol-based copolymer such as a polyvinyl acetate-vinyl alcohol copolymer, a polyethylene-vinyl alcohol copolymer, a polyvinyl alcohol-styrene copolymer, polyvinyl alcohol-vinyl chloride copolymer, and a polyvinyl alcohol-(meth)acryl copolymer, a cellulose polymer such as triacetyl cellulose, polypropylene glycol, polytetraethylene glycol, polybenzyl alcohol, and a water-soluble polymer including a plurality of hydroxyl groups (—OH) on a polymer chain or consisting of a copolymer thereof.

The water-swellable substrate may be manufactured by using polyvinyl alcohol and a polyvinyl alcohol-based copolymer.

A size of the transparent substrate is not particularly limited. A thickness of the transparent substrate may be 30 μm to 150 μm, more specifically, 30 μm to 120 μm, and furthermore specifically, 40 μm to 120 μm. In the case in which the manufacturing method according to the present invention is carried out in a continuous processing manner, the transparent substrate may be a type of roll-wound material. In this case, while the substrate is transported, each process is performed.

In the case in which the manufacturing method according to the present invention is carried out in a batch processing manner, a transparent substrate cut to a certain size is used.

In step a), the transparent substrate is swelled. This is for improving an elongation ratio by elongating the transparent substrate after swelling the transparent substrate, thereby improving an alignment degree of nanowire particles.

A swelling method for step a) is not particularly limited. A swelling liquid may be sprayed onto the transparent substrate, or the transparent substrate may be immersed in the swelling liquid.

Here, for example, water, an aqueous glycerin solution, and an aqueous potassium iodide solution may be used as the swelling solution. More specifically, water may be used as the swelling solution.

A swelling condition may be adjusted so that the swelling ratio of the substrate is 40% or more and less than 60%. When the swelling ratio is less than 40%, the substrate does not sufficiently swell and thus the alignment degree of the nanowire particles decreases, thereby degrading the polarization resolution. When the swelling ratio is 60% or more, a plasticizer of the substrate (e.g. a polyvinyl alcohol-based substrate) leaks, and thus the possibility of breakage of the substrate becomes high during an elongation process.

A temperature of the swelling solution may be equal to or higher than 20° C. and lower than 35° C., more specifically, 25° C. to 32° C. This temperature condition allows uniform swelling in a thickness direction and secures a higher swelling ratio. Therefore, the possibility of breakage during an elongation process may be reduced, and a swelling time may be set to a degree that may be applied to an actual mass-producing process.

When the temperature of the swelling solution is lower than 20° C., the substrate swells non-uniformly in a thickness direction (a phenomenon in which a surface of the substrate mainly swells and the inside of the substrate barely swells), causing breakage of the substrate during the elongation process. Further, to obtain the same effect as a swelling process performed at a swelling solution temperature equal to or higher than 20° C., an excessively long swelling time difficult to be applied to a process is required. When the temperature of the swelling solution is equal to or higher than 35° C., it is difficult to adjust the swelling ratio to less than 60% within the swelling time that may be actually applied to an actual mass-producing process.

Under the above-mentioned swelling temperature, a swelling time may be adjusted to 30 seconds to 60 seconds. It may be limited in terms of a process to adjust the swelling time to less than 30 seconds under the above-mentioned swelling temperature. When the swelling time longer than 60 seconds, the swelling ratio may exceed 60%, causing breakage of the substrate during the elongation process.

To improve mechanical strength of the substrate, a small amount of boric acid may be added to the swelling solution. Here, the amount of boric acid may be 0.5 wt % to 5 wt %, more specifically, 1.0 wt % to 4.5 wt %, and even more specifically, 1.5 wt % to 4.5 wt %. When the boric acid is added in an amount of less than 0.5 wt %, the effect of improving the mechanical strength of the substrate may not be expected. When the boric acid is added in an amount of more than 5 wt %, elongating efficiency during elongating the substrate may be degraded.

Next, in step b), a solution containing nanowire particles is coated onto one side of the swelled transparent substrate. This is for forming a reflective layer by coating the nanowire particles.

Here, the nanowire particles are metal or inorganic materials, e.g. gold, silver, copper, aluminum, iron, nickel, titanium, tungsten, and chrome, more specifically, gold, silver, aluminum, and chrome, and even more specifically, gold, silver, and aluminum.

A solvent, which may stabilize metal nanowire particles and suppress forward reaction and side reaction between the nanowire particles and the solvent, may be used to disperse the nanowire particles. For example, water; ketone such as methyl ethyl ketone, cyclohexanone, and methyl isobutyl ketone; alcohol such as ethanol, n-propanol, isopropanol, n-butanol, and diacetone alcohol; ether such as tetrahydro furan, ethyl ether, and dioxan; aliphatic hydrocarbon such as toluene; amide such as dimethyl formamide; fluoric solvent such as 2,2,3,3-tetrafluoro propanol; and glycol ether such as ethylene glycol monomethyl ether may be used as the solvent. More specifically, water may be used as the solvent.

The solution containing nanowire particles may contain a compound absorbed by the nanowire particles or a stabilizer such as a surfactant in order to reduce aggregation and precipitation of the metal nanoparticles in the solvent. A compound containing —SH, —CN, —NH₂, —SOOH, —OPO(OH)₂, —COOH, —SO₃, M, —COOM (M is a hydrogen atom, an alkali metal atom, or an ammonium molecule) may be used as the absorption compound. An anionic surfactant, a nonionic surfactant, and a hydrophilic polymer may be used as the surfactant.

Further, various additives such as a leveling agent, an antistatic agent, and a UV absorbing agent may be added to the solution containing nanowire particles as necessary.

A method for coating the solution containing nanowire particles is not particularly limited. The solution containing nanowire particles may be coated on one side of the substrate by using a conventional method such as a spin coating method, a dip coating method, a bar coating method, or a spraying method.

A coating thickness of the solution containing nanowire particles may be adjusted so that a thickness thereof after drying is 80 nm to 500 nm. Here, the thickness after drying refers to a thickness of a nanowire, and the nanowire thickness relates to a wavelength of reflected light. The above-mentioned range is a thickness range to induce reflection of light of visible light area. When the thickness is outside of this range, light of an unintended wavelength (e.g. UV and IR) may be reflected, and thus it is difficult to use the reflective polarizing film as an optical film for a display.

Next, in step c), the coated transparent substrate is unidirectionally elongated. This is for unidirectionally aligning the nanowire particles coated on one side of the transparent substrate by elongation.

A method for the elongation of step c) is not particularly limited, and thus a conventional method may be performed by using an appropriate elongator such as a tender elongator.

An elongation ratio during the elongation process is 50% to 1000% with respect to a length of the swollen transparent substrate. When the elongation ratio is less than 50%, the alignment degree of the nanowire particles decreases and thus it is difficult to serve as a reflective polarizer. When the elongation ratio is more than 1000%, the substrate may be broken during a manufacturing process.

Next, in step d), the elongated transparent substrate is predried. This is for improving the alignment degree of the nanowire particles by correcting particles deviating from the alignment direction so that the particles are aligned in the alignment direction by drying the transparent substrate at a low temperature while maintaining liquidity.

The predrying may be performed by using a conventional method such as natural drying, air drying, and heat drying. More specifically, hot-air drying may be performed in a drying oven.

A temperature for the predrying process is not particularly limited. The predrying temperature may be 20° C. to 100° C., more specifically, 20° C. to 90° C., and even more specifically, 30° C. to 80° C. When the predrying temperature is less than 20° C., drying by heat is difficult. In the case that a predrying temperature is higher than 100° C., drying may be completed before nonaligned locally and randomly distributed partial particles have alignment characteristics. Therefore, the degree of alignment thereof may be decreased.

Next, in step e), the predried transparent substrate is dried. A method for the drying is not particularly limited, and a conventional method such as natural drying, air drying, and heat drying may be used. More specifically, hot-air drying may be performed in a drying oven.

A temperature for the drying is not particularly limited. The drying temperature may be 50° C. to 170° C., more specifically, 60° C. to 170° C., and even more specifically, 60° C. to 150° C. When the drying temperature is less than 50° C., it is limited to completely dry a solvent. When the drying temperature is higher than 170° C., the alignment degree of nanowire particles decreases due to thermal deformation of the substrate.

The reflective polarizing film manufacturing method has been described. Each of the above-described steps may be individually performed. Or, processes that can be incorporated into one process may be combined together to be performed.

The reflective polarizing film according to the present invention may be included as an element of a polarizing plate so as to serve to improve luminance of an image display device, and may be applied to a backlight assembly so as to serve to improve luminance of a liquid crystal display device.

Hereinafter, the present invention will be described in more detail with reference to examples. However, the present invention is not limited to the following examples.

### EXAMPLE 1

1. Manufacturing a Reflective Polarizing Film

A polyvinyl alcohol (PVA)-based substrate was swelled for about 30 seconds at a temperature of about 28° C. to have a swelling ratio of about 40% by using water to which 3 wt % boric acid was added as a swelling solution. Thereafter, an aqueous solution containing silver (Ag) nanowire particles was dried and then was coated onto the swelled substrate to a thickness of about 200 nm by using a meyer bar. Thereafter, the coated substrate was uniaxially elongated at a ratio of about 300% with respect to a length of the substrate. Thereafter, the substrate was hot-air dried for about 1 minute at a temperature of about 50° C. in a drying oven in order to perform predrying. Thereafter, the substrate was hot-air dried for about 10 minute at a temperature of about 95° C. in a drying oven in order to completely dry the solvent coated on the substrate. The reflective polarizer formed in this manner has a reflective layer in which silver nanowire particles are unidirectionally aligned, the reflective layer having a thickness of about 200 nm.

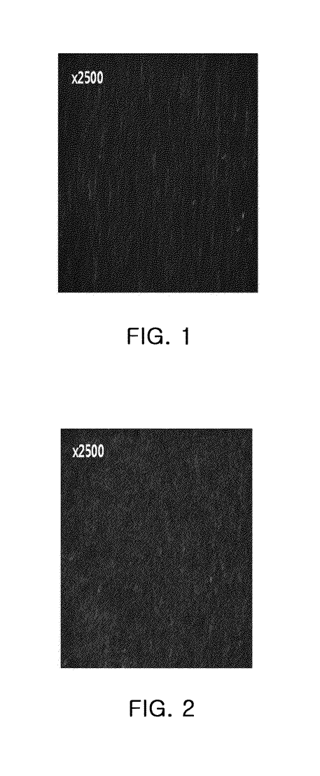

FIG. 1 is an image illustrating an alignment degree of nanowire particles of the reflective polarizing film of the example, wherein the image was captured by a reflection-type microscope (product name: VF-7510 Profile Micrometer of Keyence Corporation).

### COMPARATIVE EXAMPLE 1

1. Manufacturing a Reflective Polarizing Film

A reflective polarizing film was manufactured in the same manner as the example excepting the processes of swelling and elongating the polyvinyl alcohol (PVA)-based substrate.

FIG. 2 is an image illustrating an alignment degree of nanowire particles of the reflective polarizing film of comparative example 1, wherein the image was captured by a reflection-type microscope (product name: VF-7510 Profile Micrometer of Keyence Corporation).

### COMPARATIVE EXAMPLE 2

1. Manufacturing a Reflective Polarizing Film

A reflective polarizing film was manufactured in the same manner as the example excepting the process of swelling the polyvinyl alcohol (PVA)-based substrate.

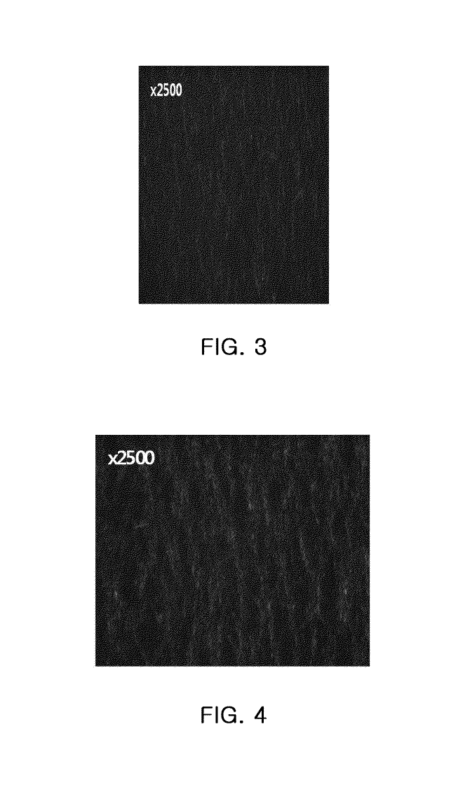

FIG. 3 is an image illustrating an alignment degree of nanowire particles of the reflective polarizing film of comparative example 2, wherein the image was captured by a reflection-type microscope (product name: VF-7510 Profile Micrometer of Keyence Corporation).

### COMPARATIVE EXAMPLE 3

1. Manufacturing a Reflective Polarizing Film

A reflective polarizing film was manufactured in the same manner as the example except that a polyvinyl alcohol (PVA)-based substrate was swelled for about 30 seconds at a temperature of about 10° C. to have a swelling ratio of about 25% by using water to which 3 wt % boric acid was added as a swelling solution.

FIG. 4 is an image illustrating an alignment degree of nanowire particles of the reflective polarizing film of comparative example 3, wherein the image was captured by a reflection-type microscope (product name: VF-7510 Profile Micrometer of Keyence Corporation).

### COMPARATIVE EXAMPLE 4

1. Manufacturing a Reflective Polarizing Film

A reflective polarizing film was manufactured in the same manner as the example except that a polyvinyl alcohol (PVA)-based substrate was swelled for about 30 seconds at a temperature of about 50° C. to have a swelling ratio of about 65% or more by using water to which 3 wt % boric acid was added as a swelling solution.

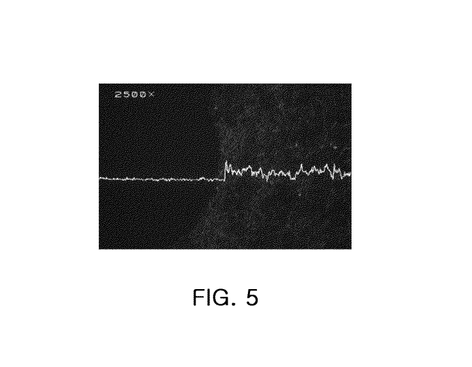

FIG. 5 is an image illustrating that the reflective polarizing film of comparative example 4 was broken due to excessive swelling, wherein the image was captured by a reflection-type microscope (product name: VF-7510 Profile Micrometer of Keyence Corporation).

In detail, comparing FIGS. 1, 3, and 4 with FIG. 2, it may be understood that a reflective polarizing film manufactured by coating a transparent substrate with nanowire particles and then elongating the substrate has a greater alignment degree of nanowire particles than that of a reflective polarizing film manufactured by coating a transparent substrate with nanowire particles without elongating the substrate. Comparing FIG. 1 with FIGS. 3 and 4, it may be understood that a reflective polarizing film manufactured by swelling a transparent substrate and then elongating the substrate has a greater alignment degree of nanowire particles (distribution of nanowire particles aligned in a certain direction is high) than that of a reflective polarizing film manufactured by performing the elongation process in a state where the swelling process is not performed or the swelling does not appropriately occur.

Referring to FIG. 5, it may be understood that the transparent substrate is broken when the transparent substrate is elongated after being swelled to more than an appropriate degree, and therefore, a reflective polarizing film can not be manufactured.

### EXPERIMENTAL EXAMPLE

### Measuring Transmittance According to Polarization

Transmittances of the reflective polarizing films of the example and comparative examples 1 to 3, according to polarization, were measured. In detail, transmittance of TM polarization vertical to an alignment direction of nanowire particles and transmittance of TE polarization parallel to the alignment direction of nanowire particles were measured by using an N&K spectrophotometer.

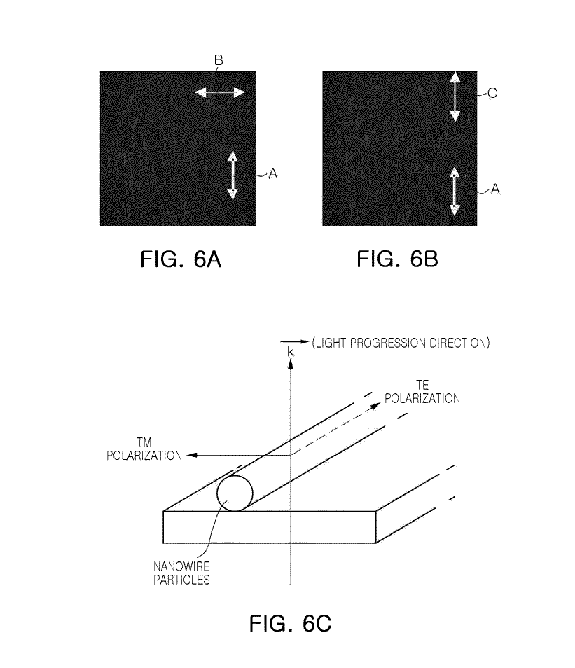

Polarization is classified into the TM polarization vertical to the alignment direction of nanowire particles and the TE polarization parallel to the alignment direction of nanowire particles. FIGS. 6(a) and 6(b) respectively illustrate a TM polarization direction and TE polarization direction of light transmitted by nanowire particles. FIG. 6(c) illustrates a relationship between the alignment direction of nanowire particles and the TM and TE polarizations. In FIG. 6, ‘A’ indicates the alignment direction of nanowire particles, ‘B’ indicates the TM polarization direction, and ‘C’ indicates the TE polarization direction.

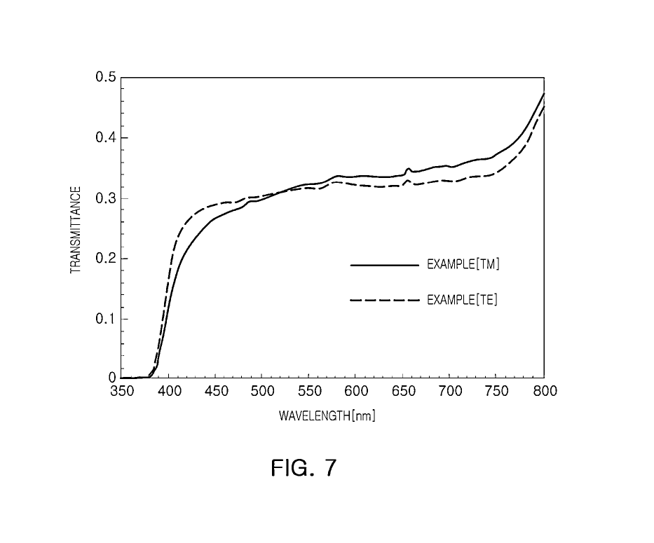

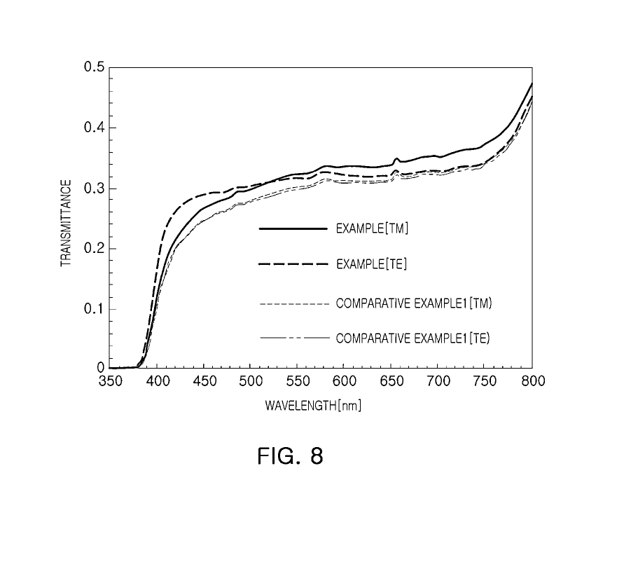

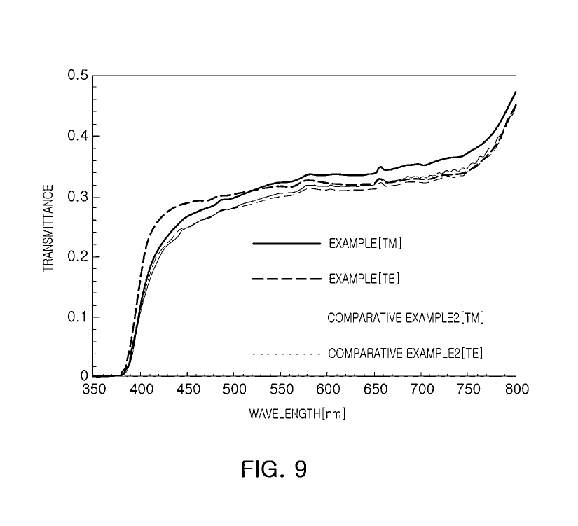

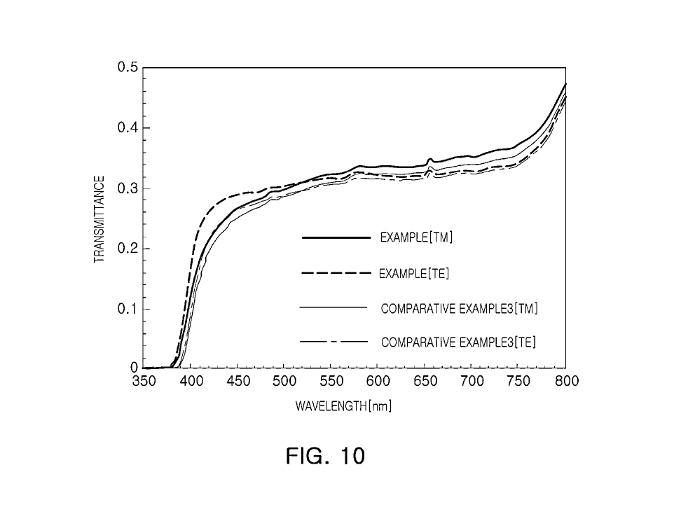

FIG. 7 is a graph illustrating transmittance the reflective polarizing film of the example with respect to polarization. FIG. 8 is a graph illustrating a comparison between transmittances of the reflective polarizing films of the example and comparative example 1 with respect to polarization. FIG. 9 is a graph illustrating a comparison between transmittances of the reflective polarizing films of the example and comparative example 2 with respect to polarization. FIG. 10 is a graph illustrating comparison between transmittances of the reflective polarizing films of the example and comparative example 3 with respect to polarization.

Referring to FIGS. 7 to 10, it may be understood that, compared with the reflective polarizing films of comparative examples 1 to 3, the reflective polarizing film of the example has high transmittance according to polarization and has excellent polarization resolution since a difference between transmittance of TM polarization and transmittance of TE polarization is great.

On the contrary, it may be understood that the reflective polarizing films of comparative examples 1 to 3 have a very small difference or almost no difference between transmittance of TM polarization and transmittance of TE polarization. Therefore, it may be understood that the reflective polarizing films of comparative examples 1 to 3 have poor polarization resolution in comparison with the reflective polarizing film of the example.

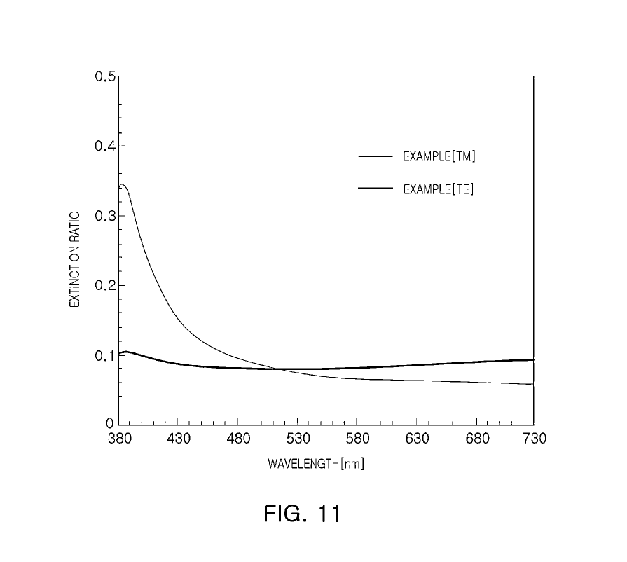

An extinction ratio of a polarizing film was calculated by assigning, to Equation 1 shown below, transmittance of polarization light transmitted by the reflective film of the example. Distribution of extinction ratios according to polarization is illustrated in FIG. 11.

Extinction ratio=log [T₀/T] Equation 1

Where T₀ denotes initial transmittance of polarization light transmitted by a reflective polarizing film, and T denotes transmittance of polarization light after being transmitted by the reflective polarizing film.

Referring to FIG. 11, according to the reflective polarizing film of the example, there exists a wavelength λᵣₑₛ in which an extinction ratio is maximized with respect to TM polarization. This indicates that surface plasmon resonance phenomenon occurs. With respect to TE polarization, the wavelength λᵣₑₛ in which the extinction ratio is maximized does not exist. Here, the surface plasmon resonance phenomenon refers to a phenomenon in which light is blocked in a surface of metal as a result of interaction between metal nanoparticles and free electrons, and, as a result of surface plasmon resonance, light is strongly absorbed. In general, according to a type of metal particles of nanowire particles, a wavelength range of absorbed light is different. In the case of the example, silver nanowire particles are used. Therefore, as illustrated in FIG. 11, there exists the wavelength λᵣₑₛ in which the extinction ratio is maximized in a wavelength range of 380 nm to 400 nm with respect to TE polarization.

As illustrated in FIG. 11, the plasmon resonance phenomenon occurs with respect to TM polarization, but does not occur with respect to TE polarization. This indicates that a degree of aligning nanowire particles in a certain direction (TE polarization direction) is high, and thus, characteristics of polarization separation are excellent.

The reflective polarizing film of the present invention includes a reflective layer (nanowire grid) unidirectionally elongated to be formed on one side of a transparent substrate. Therefore, unlike a conventional reflective polarizing film, a series of processes (thin film deposition, photoresist coating, lithography, etching) for patterning is not needed. Therefore, a manufacturing process can be simplified and a manufacturing cost can be reduced.

Further, by applying the reflective polarizing film of the present invention to a polarizing plate and a backlight assembly, luminance of a liquid crystal display device can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A reflective polarizing film comprising:
a transparent substrate; and
a reflective layer unidirectionally elongated to be formed on one side of the transparent substrate,
wherein the reflective layer is composed of nanowire particles, and
80% or more of the nanowire particles are aligned at an angle of −10° to 10° with respect to an elongation direction.

2. The reflective polarizing film of claim 1, wherein the transparent substrate is a water-swellable substrate.

3. The reflective polarizing film of claim 2, wherein the transparent substrate is manufactured by using polyvinyl alcohol or a cellulose polymer.

4. The reflective polarizing film of claim 1, wherein the reflective layer is elongated at a ratio of 50% to 1000% to be formed.

5. The reflective polarizing film of claim 1, wherein a thickness of the reflective layer is 50 nm to 1000 nm.

6. The reflective polarizing film of claim 1, wherein a thickness of the reflective layer is 80 nm to 500 nm.

7. The reflective polarizing film of claim 1, wherein the nanowire particles are metal and inorganic materials.

8. A method of manufacturing a reflective polarizing film, the method comprising the steps of:
a) swelling a transparent substrate to have a swelling ratio of 40% or more and less than 60% by using a swelling solution;
b) coating a solution comprising nanowire particles onto one side of the swelled transparent substrate;
c) unidirectionally elongating the coated transparent substrate;
d) predrying the elongated transparent substrate; and
e) drying the predried transparent substrate.

9. The method of claim 8, wherein the transparent substrate is a water-swellable substrate.

10. The method of claim 8, wherein, at the step of a), wherein the swelling solution is one of water, aqueous glycerin solution, and aqueous potassium iodide solution.

11. The method of claim 10, wherein boric acid is added to the swelling solution.

12. The method of claim 11, wherein the boric acid is added in an amount of 0.5 wt % to 5 wt %.

13. The method of claim 8, wherein, at the step of a), a temperature of the swelling solution is equal to or higher than 20° C. and lower than 35° C.

14. The reflective polarizing film of claim 8, wherein, a thickness of the reflective polarizing film after the step of e) is adjusted to 80 nm to 500 nm.

15. The method of claim 8, wherein, at the step of c), an elongation ratio is 50% to 1000%.

16. The method of claim 8, wherein the step of d) is performed at a temperature of 20° C. to 80° C.

17. The method of claim 8, wherein the step of e) is performed at a temperature of 50° C. to 170° C.

18. The method of claim 8, wherein the step of e) is performed at a temperature of 70° C. to 150° C.

19. A polarizing plate comprising the reflective polarizing film of claim 1.

20. A backlight assembly comprising the reflective polarizing film of claim 1.

21. An image display device comprising the polarizing plate of claim 19.

22. The image display device of claim 21, wherein the image display device is an organic EL image display device.

23. The image display device of claim 21, wherein the image display device is a liquid crystal display (LCD) device.

24. The image display device of claim 23, wherein an operating mode of the liquid crystal display device is an in-plane switching (IPS) mode, a twisted nematic (TN) mode, a vertically aligned (VA) mode, or a fringe field switching (FFS) mode.

25. A liquid crystal display device comprising the backlight assembly of claim 20.

26. The liquid crystal display device of claim 25, wherein an operating mode of the liquid crystal display device is an in-plane switching (IPS) mode, a twisted nematic (TN) mode, a vertically aligned (VA) mode, or a fringe field switching (FFS) mode.
